(19) United States
(12) Patent Application Publication
(10) Pub. No.: US 2017/0213006 A1
(43) Pub. Date: Jul. 27, 2017

(54) INTELLIGENT MOBILE HOMEWORK ADHERENCE AND FEEDBACK APPLICATION FOR TELEHEALTH

(71) Applicants: Ryan Gordon Beale, Huntington Woods, MI (US); Mark Ellis Jaruzel, II, Farmington Hills, MI (US)

(72) Inventors: Ryan Gordon Beale, Huntington Woods, MI (US); Mark Ellis Jaruzel, II, Farmington Hills, MI (US)

(73) Assignee: The Live Network Inc., Northville, MI (US)

(21) Appl. No.: 15/415,438

(22) Filed: Jan. 25, 2017

Related U.S. Application Data
(60) Provisional application No. 62/287,649, filed on Jan. 27, 2016.

(51) Int. Cl. G06F 19/00; G06N 3/08; G06N 99/00; G06F 21/62; G06F 17/30

(52) U.S. Cl. CPC G06F 19/3418; G06F 21/6254; G06F 17/30312; G06N 99/005; G06N 3/08; G06Q 10/109

(57) ABSTRACT

The present invention relates to a computerized system for and methods of securely providing precision healthcare services related to the AI-optimized prescribing and monitoring of behavioral health homework at a distance. The system is continually learning in a recursive manner such that the output of one set of patient experiences are added to the AI system to further refine future patient recommendations with regard to prescribed homework assignments. The present invention is unlimited with regard to the type of patient entity or healthcare professional entity.

### REFERENCE TO RELATED APPLICATIONS

This application claims an invention which was disclosed in Provisional Application No. 62/287,649, filed Jan. 27, 2016, entitled “MOBILE HOMEWORK ADHERENCE AND FEEDBACK APPLICATION FOR TELEMEDICINE, TELEHEALTH, AND TELEPSYCHOLOGY”. The benefit under 35 USC §119(e) of the United States provisional application is hereby claimed, and the aforementioned application is hereby incorporated herein by reference.

### ACKNOWLEDGMENT OF GOVERNMENT SUPPORT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

The inventors have a copending application Ser. No. 15/377,490, filed Dec. 13, 2016, entitled “TREATMENT INTELLIGENCE AND INTERACTIVE PRESENCE PORTAL FOR TELEHEALTH.” The aforementioned application describes a system and set of methods that are related to this application.

### BACKGROUND OF THE INVENTION

Field of the Invention

The invention pertains to the field of healthcare services and wellness. More particularly, the invention pertains to a computerized system for and method of providing precision healthcare services related to the individualized treatment of mental and emotional health concerns and distress at a distance through homework assignments and client prompts to complete prescribed homework assignments.

Description of Related Art

A mental health disorder, also commonly referred to as a mental illness, is a pattern of mood, cognition, behavior, or personality that occurs in a person and is thought to cause distress or disability that is not a normal part of development or culture. Mental health disorders are quite common. In the United States, the American Psychiatric Association estimates that over 68 million Americans will meet diagnostic criteria for a psychiatric or substance use disorder in a given year. The costs associated with treated, undertreated, and untreated mental illnesses are high with The World Economic Forum estimating worldwide costs were $2.5 trillion for 2010.

In addition to mental health disorders proper, there are a range of associated behavioral health concerns related to chronic disease management, medication adherence, healthy lifestyle maintenance, and managing risky behaviors. These behavioral aspects of healthcare can complicate or compromise patient health, functioning, prognosis, time to recovery, and duration of recovery.

One commonly employed treatment for mental health disorders and problematic behavioral aspects of medical conditions is psychotherapy. Psychotherapy has been shown to be effective for treating many different specific diagnoses as well as for treating patients suffering from multiple comorbid diagnoses. Existing studies strongly suggest that psychotherapy is generally effective for mental health disorders with an effect size greater than that of antidepressant medications. The literature suggests that the general effect size for psychotherapy is moderate to large (Cohen's d>0.5). Common psychotherapeutic practice and research literature on the same has suggested that assigned homework activities can be an important part of the practice of psychotherapy.

The United States Department of Health and Human Services has noted that text messaging programs can bring about behavior change to improve smoking cessation outcomes as well as diabetes management and outcomes. Research has also shown that text messaging improves treatment compliance, medication adherence, and appointment attendance. Research suggests that text messaging may improve immunization rates, increase sexual health knowledge, and reduce risky behaviors related to HIV transmission. Prompts to follow up with prescribed psychotherapy homework can also improve adherence to the recommended homework.

Recent advances in technology have made it easier to integrate mobile notifications across a range of programs, devices, and peripherals. Recent advances in artificial intelligence (AI) and machine learning have rapidly accelerated the pace at which computer systems can match or surpass basic human expertise in tasks as diverse as playing chess, recommending products, answering trivia questions, suggesting cancer treatments, and driving cars. Applying these advanced systems to preliminary patient matching with homework suggestions, adherence prompts and adherence monitoring, and subsequent treatment plan optimization, can improve outcomes in mental health treatment. Beyond just prompting or reminding patients of prescribed activities, it is now possible to integrate adherence monitoring and machine learning components into prescribed patient homework activities.

### SUMMARY OF THE INVENTION

The present invention advantageously provides systems and methods to securely provide precision psychotherapy homework reminders and other professional mental health interventions that are customized for the patient served at a distance. When patients initially interact with the system, they will bring with them a wealth of data derived from numerous sources. This data may include information such as demographic, genetic, assessment, diagnosis, treatment, history, outcome, wearable, mobile device, augmented reality device, social network, and totem data. When this data is coupled with healthcare professional input and analyzed by AI methods, the system can suggest prescribed homework assignments tailored to optimize patient satisfaction and outcome.

The system is continually learning in a recursive manner such that the output of one set of patient experiences are added to the AI system to further refine future patient recommendations with regard to prescribed homework assignments. The system will allow one or more healthcare professionals to communicate prescribed homework recommendations to one or more patients at a distance and to receive feedback about patient adherence to the prescribed regimen. The system will support the healthcare professional's decision process with real-time data displays about the patient's present circumstances and adherence to prescribed homework regimes.

The system will continually monitor patient follow up with prescribed homework activities via a system of patient reminders and prompts. Depending on the devices available to the patient and permissions given by the patient, the system will be able to send reminders to the patient about prescribed homework activities across a range of devices (including but not limited to: cellular phones, smartphones, smartwatches, augmented reality displays, wearables, smart objects, digital assistants, and smart homes). The patient will be able to mark the given activity as completed, incomplete, or choose to snooze the activity such that the system will prompt them again to complete the prescribed activity at a later time. Each such action on the part of the client (including no response) will be logged by the system and included as a part of the patient's treatment record allowing both the healthcare professional and patient a much more accurate view of the patient's adherence to the prescribed regimen.

The overall system will give patients better chances for positive experiences and positive outcomes. The system will assist in finding the best fit between patient and homework activities. The system will help the healthcare professional and patient make more honest and accurate determinations about the effectiveness of interventions during the course of the treatment rather than only after the fact (if at all). The system will assist the users in transcending the distances between patient need and relevant and effective professional assistance.

The present invention is not intended to be limiting in the nature of the entity that is the healthcare provider or the nature of the entity that is the patient. It is expected that the present invention will be used by a diverse range of healthcare professionals and patients.

### BRIEF DESCRIPTION OF THE DRAWINGS

Further advantageous features of the present invention will become more apparent when the following detailed description is taken along with reference to the accompanying drawings in which:

FIG. 1 shows a functional block diagram of hardware, software, or a combinational instance thereof that may be implemented in one or more computer systems or processing systems, whether local or cloud based, to carry out the functionality of the system as a whole, in accordance with one embodiment of the present invention.

FIG. 2 shows an example of the homework assignment screen graphical user interface according to one embodiment of the present invention.

FIG. 3 shows an example of the patient homework prompt graphical user interface on a device screen according to one embodiment of the present invention.

FIG. 4 shows an example of a patient snoozing a homework prompt on the patient homework prompt graphical user interface on a device screen according to one embodiment of the present invention.

FIG. 5 shows an example of the re-presentation prompt of a snoozed homework activity graphical user interface on an augmented reality virtual display according to one embodiment of the present invention.

FIG. 6 shows an example of the healthcare professional encrypted portal for reviewing patient homework activities, adherence, and progress to date as well as other aspects of the patient's record according to one embodiment of the present invention.

FIG. 7 shows how AI processes recursively use patient adherence data and other data to inform future patient and healthcare provider suggestions regarding treatment according to one embodiment of the present invention.

### DETAILED DESCRIPTION OF THE INVENTION

The present invention advantageously provides systems and methods to securely provide precision psychotherapy homework reminders and other professional mental health interventions that are customized for the patient served at a distance.

As discussed above, the present invention relates to a computerized system for and methods of securely providing precision healthcare services related to the AI-optimized monitoring of prescribed behavioral health homework at a distance. Several aspects of the present invention provide novel advances in the provision of telemedicine and telepsychology (sometimes also referred to as: “telehealth,” “telemental health,” “telepsychiatry,” and “telebehavioral health”) and the system as a whole provides a novel integrated platform for the assignment and monitoring of healthcare interventions, especially psychotherapeutic homework interventions, at a distance.

Embodiments of the present invention will accelerate the interactive dialogue between healthcare practice, interventions, and outcomes. The present system allows for iteration and recursive learning to occur in real time or near real time so that patients and healthcare professionals can make treatment decisions informed by outcome information during, rather than after, the course of treatment. The system as a whole could eventually be informed by many thousands of years of professional experience and many thousands of lived years of patient experience. Using the wisdom and information about distress and the amelioration of distress that is both explicitly and tacitly contained within these users, the system will begin to recognize previously unknown patterns in real time so as to suggest additional and/or alternative homework options for consideration. This will allow for unprecedented treatment matching both at the level of general homework interventions for general disorders and at the level of the individual patient and their unique presentation and patterns of adherence.

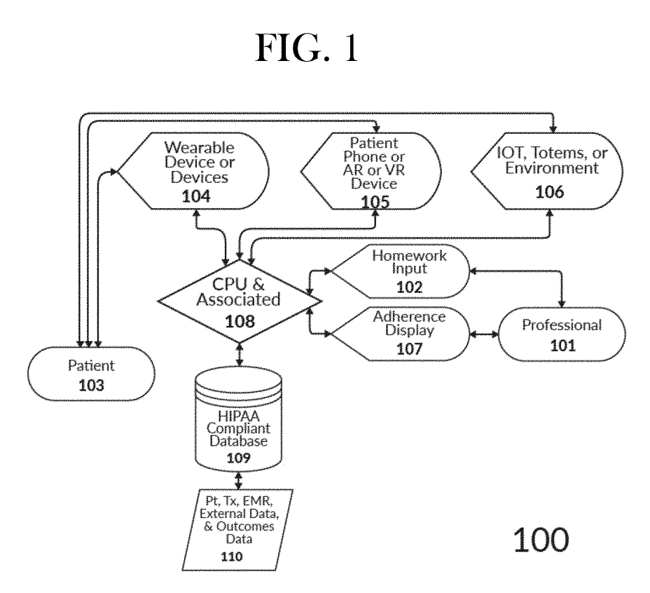

FIG. 1 illustrates a functional block diagram of an example computing system 100 in accordance with one embodiment of the present invention. The example computing system 100 shows how a professional 101 can communicate prescribed homework assignments or reminders thereof to a patient 103 at a distance that are informed by patient data derived from a diversity of sources. The example computing system 100 could be comprised of hardware, software, or a combinational instance thereof that may be implemented in one or more computer systems or processing systems, whether local or cloud based, to carry out the functionality of the system as a whole.

In this system 100, a professional 101 will be presented with a number of suggested homework assignments for a given patient 103 via a homework assignment screen graphical user interface 102. These recommendations will be generated by artificial intelligence (AI) methods employed by the central processing unit and associated components (CPU) 108 with input from patient data derived from a range of different sources (including but not limited to: the patient 103, wearable devices 104, smartphone data 105, and smart environment components 106) and available outcome data and other system data 110, stored in the secure database 109. The professional will assign prescribed homework activities via the homework assignment graphical user interface 102 and those prescribed activities will be logged as a part of the data 110 stored in the secure database 109.

The homework activities selected by the professional 101 will be delivered to the patient 103 via one or more methods, depending on the devices that are available to the patient and the permissions given by the patient. Examples of devices where the patient 103 might receive such a prompt could include the patient's smartphone or augmented reality interface 105, a wearable device or smartwatch 104, or a smart environment interface 106. The patient 103 will then be prompted to report on the status of their adherence to the homework activity prescribed. The patient 103 will be able to report that they completed the activity as prescribed, did not complete the activity as prescribed, or that they wish to be prompted again in the near future (“snooze”). The patient's response or nonresponse will be recorded in the outcomes data 110 stored in the secure database 109.

The professional 101 will be able to view a report of the patient's 103 reported adherence to the homework activities as prescribed on the healthcare professional encrypted portal 107. In this way, the professional 101 will have data with which to make an informed decision about whether to continue a prescribed homework assignment as a part of the patient's 103 overall treatment or to modify or discontinue the homework assigned. In one embodiment of the present invention, the professional encrypted portal 107 will also include contextual information about how well other patients adhere to the same homework activities and how much similar patients have benefitted from the same homework activities. This contextual data will be continually updated with relevant outcome data 110 stored on the secure database 109.

The professional 101 will benefit from the system 100 because of the additional information available to support rational interventions on the patient's 103 behalf and the patient 103 will benefit from the system 100 because they will be more likely to have effective homework interventions included in the treatment.

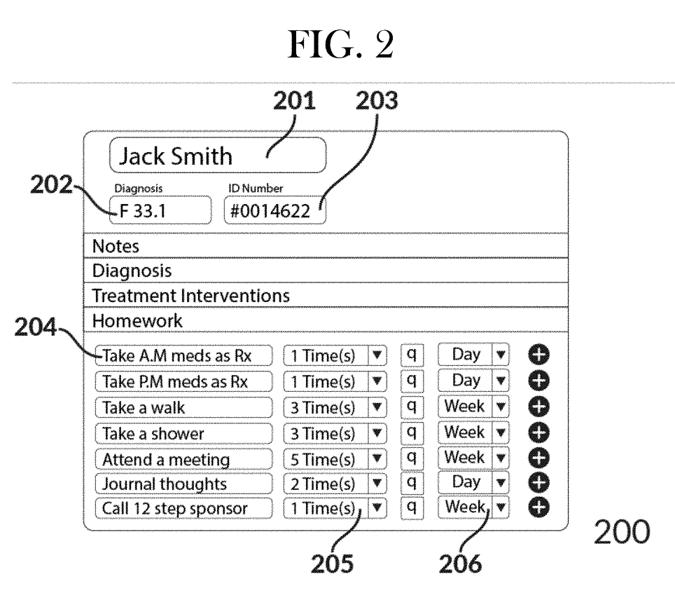

FIG. 2 illustrates an example of the homework assignment screen graphical user interface 200 according to one embodiment of the present invention. On this screen 200, a professional may review aspects of the patient's chart and make modifications, especially as pertains to the patient's prescribed homework activities 204 or other behavioral health activities to be completed between consulting sessions.

The professional will be able to see the patient's name 201, primary diagnosis or focus of treatment 202, and the patient's chart number or identification number 203. The professional will be able to select from a list of AI-recommended homework options or they may manually input a different prescribed regimen under the homework section 204. The professional may also select the prescribed frequency 205 that the intervention is to occur within a given period of time 206.

Any changes or other input entered by the professional will be stored by the system and used to generate appropriate prompts for the patient to engage in the prescribed activities at the frequency recommended.

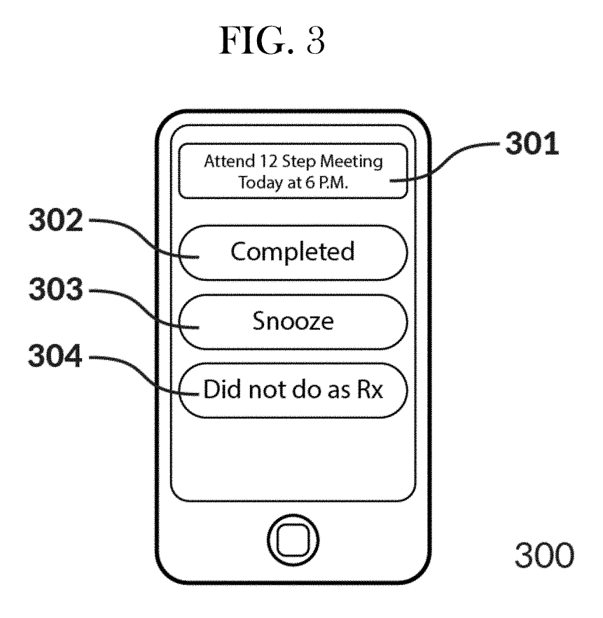

FIG. 3 illustrates an example of the patient homework prompt graphical user interface on a device screen 300 according to one embodiment of the present invention. In this figure, a patient has been sent a homework prompt 301 from the system and the patient is asked to select if they have completed the assignment already 302, wish to “snooze” the assignment 303 (be prompted again at a later time about the homework assignment), or wish to report that they have not done the activity that was prescribed 304. Whichever button is selected will be registered by the system and stored. If the patient does not respond within a given window of time, their nonresponse will also be recorded.

This response window may be a generally set parameter or a parameter that is tailored to the particular patient or intervention whether by the prescribing professional or the system. In any case, the patient's action or inaction will be logged by the system and the system will use this information both to make a determination about whether to send the patient additional prompts about the activity as well as to make determinations about other aspects of the patient's treatment.

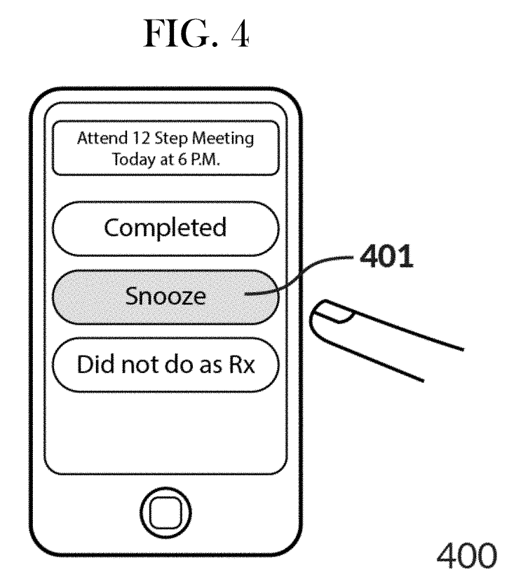

FIG. 4 illustrates an example of a patient snoozing a homework prompt on the patient homework prompt graphical user interface on a device screen 400 according to one embodiment of the present invention. In this figure, a patient has elected to “snooze” 401 the reminder about the prescribed behavior. The system will log this answer and re-present the prompt at a later time. The duration of time between patient hitting snooze 401 and the prompt being re-presented may be a generally set parameter or a parameter that is tailored to the particular patient or intervention whether by the prescribing professional or the system.

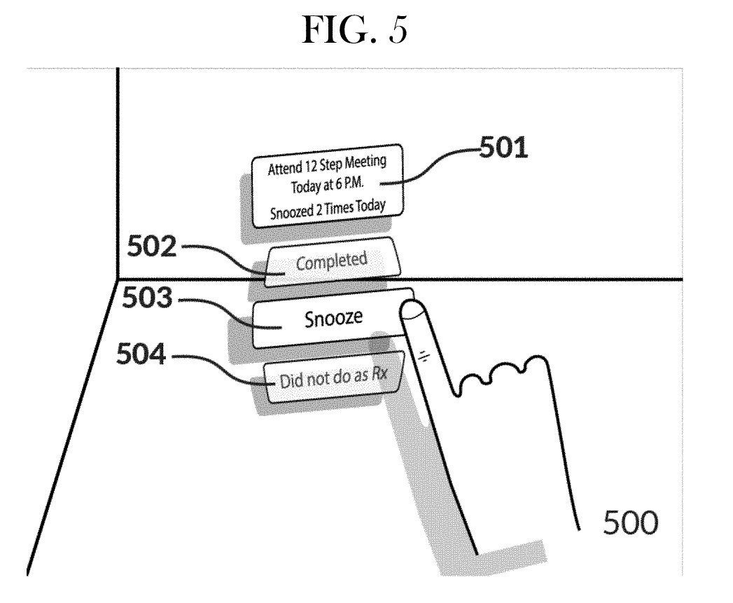

FIG. 5 illustrates an example of the re-presentation prompt of a snoozed homework activity graphical user interface on an augmented reality virtual display 500 according to one embodiment of the present invention. In this figure, a patient has been re-presented with a previously “snoozed” prescribed homework activity 501. The notification makes it clear that the patient has already snoozed this reminder 501, and offers the patient the opportunity to mark the prescribed activity as completed 502, to snooze the reminder again 503, or to report that they did not do the activity as prescribed 504. Whichever button is selected will be registered by the system and stored. If the patient does not respond within a given window of time, their nonresponse will also be recorded. This response window may be a generally set parameter or a parameter that is tailored to the particular patient or intervention whether by the prescribing professional or the system. In any case, the patient's action or inaction will be logged by the system and the system will use this information both to make a determination about whether to send the patient additional prompts about the activity as well as to make determinations about other aspects of the patient's treatment.

At some point, the system will stop sending out reminder prompts to the patient about a given instance of a prescribed homework activity because the patient will have selected the completed option 502, because the patient will have selected the did not complete as prescribed option 503, or the system will have determined the instance of the assignment to be expired. The determination of whether or not a prescribed homework activity has expired may be a generally set parameter or a parameter that is tailored to the particular patient or intervention whether by the prescribing professional or the system.

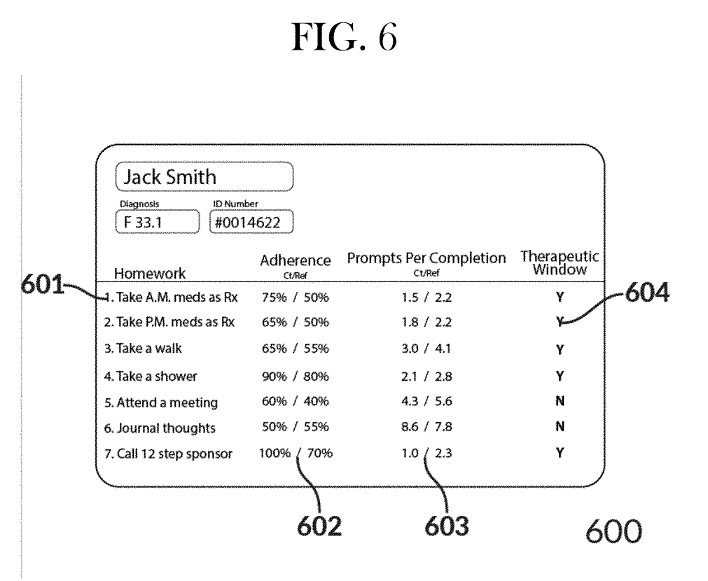

FIG. 6 illustrates an example of the healthcare professional encrypted portal for reviewing patient homework activities, adherence, and progress to date as well as other aspects of the patient's record 600 according to one embodiment of the present invention. In this figure, a professional is presented with a summary of a patient's reported adherence to homework activities. This summary lists the name of the homework prescribed 601, the patient's reported adherence to the homework as prescribed 602, the mean or actual number of prompts required per instance of patient reported adherence 603, and whether the system considers the patient's adherence to the activity prescribed to be within a therapeutic window of efficacy 604.

All prescribed homework assignments are displayed and named 601. The professional can easily see which interventions are a part of the prescribed course of behaviors on this display 600.

The professional can also see what the patient's reported adherence rate has been for the prescribed activities and how this relates to reference adherence rates for the activity 602. The system, by means of tabulation, machine learning algorithms, or other methods, will present a relevant reference for the prescribed activity in question. This will allow a professional to rapidly see how their patient compares with other patients. The criteria for comparison could be reported adherence across all instances of the prescribed homework, reported adherence across all instances of a particular diagnosis or problem focus, or a computer generated reference that takes into account multiple variables.

The professional can also see what the patient's ratio of prompts per reported completion has been for the prescribed activities and how this relates to reference prompt ratios for the activity 603. The system, by means of tabulation, machine learning algorithms, or other methods, will present a relevant reference for the prescribed activity in question. This will allow a professional to rapidly see how their patient compares with other patients. The criteria for comparison could be prompts per reported adherence across all instances of the prescribed homework, prompts per reported adherence across all instances of a particular diagnosis or problem focus, or a computer generated reference that takes into account multiple variables.

The professional will also be presented with a determination about whether the patient's reported adherence rate is likely to be within a therapeutic window or window of efficacy 604. The system, by means of tabulation, machine learning algorithms, or other methods, will make a determination for the prescribed activity in question. This will allow a professional to rapidly see if their patient is likely to be benefitting from a particular prescribed activity or not. This determination will likely draw on the overall system's data regarding patient variables, past outcomes, and diagnostic or other assessment data to make such a determination.

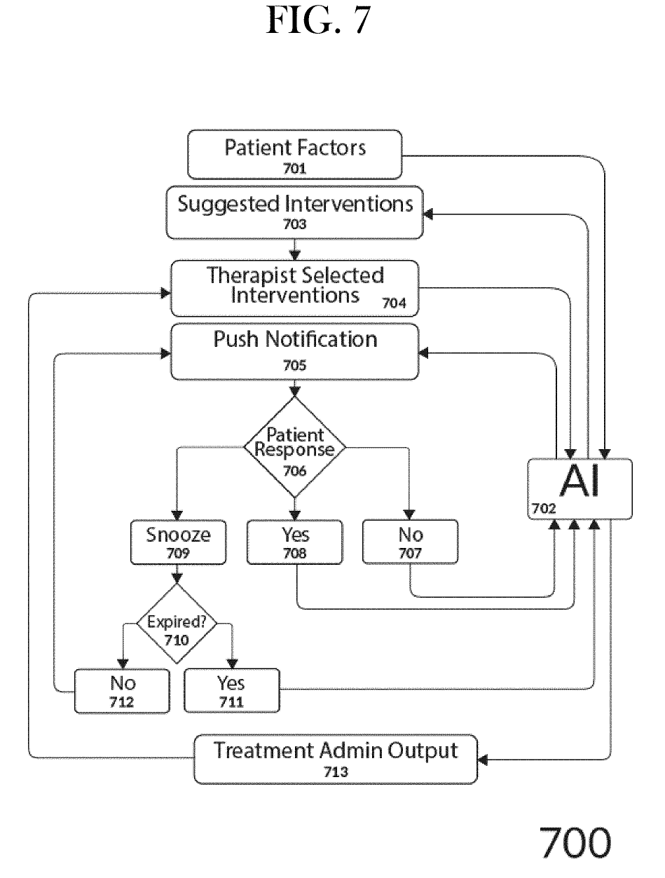

FIG. 7 illustrates how artificial intelligence (AI) processes recursively use patient adherence data and other data to inform future patient and healthcare provider suggestions regarding treatment 700 according to one embodiment of the present invention. This figure, describes the process flow for the AI portion of the presently described invention 700. A large part of what makes the system as a whole advantageous to professionals and patients alike, is the introduction of basic and advanced AI methods to optimize treatment selection and to provide recursive feedback to the system as a whole about the relationships between various client variables, homework variables, and outcomes.

The system starts with input from the patient in the form of patient factors 701 (which could include patient demographics, known patient history, patient device data, and initial or formative assessments). The AI system 702 using methods such as (but not limited to): deep learning, neural network modeling, parallel distributed processing, low-rank matrix factorization, regression analysis, vectorization, and skip thought vectors then suggests potential homework assignments to the professional 703 based on a range of variables including but not limited to: interventions typically employed by the professional, client prognoses, homework assignments given in the past, theoretical orientation, efficacy rating, discipline, and professional demographic data.

Unlike other treatment algorithms where all patients with a given diagnosis are offered a single treatment assumed to be best (often based on information from small number trials in contexts that differ from typical professional practice), the AI system 702, in one embodiment of the present system, will offer the professional four distinct sets of “top 5” interventions for the patient's identified focus or diagnosis. It will offer a list of the professional's own 5 most commonly prescribed homework interventions by simple frequency. It will offer a list of the 5 most commonly prescribed homework interventions by the professional's particular profession (psychologist, social worker, nurse, psychiatrist, etc.). It will offer a list of the 5 most commonly prescribed homework interventions by the professional's theoretical orientation (cognitive, behavioral, psychodynamic, humanistic, family systems, etc.). It will also offer a suggested list of optimized homework interventions based on the total available data. The professional will be free to use or not use any of the given recommendations as the system, in one embodiment of the present invention, will defer to the professional's judgment. In any case, the professional will create a plan of service and select one or more prescribed homework interventions 704. The composition of this plan will be recorded by the AI system 702.

The AI system 702 will then send out push notifications 705 to the patient based on the homework that was assigned by the professional 704. The patient will be prompted to respond and report on their adherence to the homework activity as prescribed 706. If the patient either reports that no they did not do the homework as prescribed 707 or that yes they did do the homework as prescribed 708, their answers will be sent to the AI system 702 and logged as a part of their treatment data. If the patient chooses to snooze the prompt 709 the system or the interfacing device will check to see if the homework activity is now expired 710. If the answer is yes 711, the data is logged to the system. If the answer is no 712, the client will be re-presented with a push notification 705 at a later time within a relevant window specified either by the system or the prescribing professional.

Given the totality of data generated in this fashion, the AI component of the system 702 will summarize the patient's reported treatment adherence for the treating professional 713 and this data will be used to assist the professional in periodic reviews of the patient's course of interventions by presenting an assessment of the likely efficacy of the interventions currently prescribed and suggesting possible alternative homework interventions 704. This iterative process will continue throughout the course of the patient's treatment with the system 700 continually updating recommendations for optimal interventions based on the best available data.

Various user interfaces and embodiments were described above in some detail with reference to the drawings, wherein like reference numerals represented like parts and assemblies throughout the several views. Any of the preceding references to the various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover applications or embodiments without departing from the spirit or scope of the claims attached hereto. Also, it is to be understood that any of the phraseology and terminology that were used herein were for the purpose of description and should not be regarded as limiting.

Any of the devices/servers/CPUs in the above-described systems may include a bus or other communication mechanism for communicating information, which interconnects subsystems and devices, such as processor, system memory (e.g., RAM), static storage device (e.g., ROM), disk drive (e.g., magnetic or optical), communication interface (e.g., modem or Ethernet card), display (e.g., CRT or LCD), or input device (e.g., keyboard, touchscreen). The system component performs specific operations by the processor executing one or more sequences of one or more instructions contained in system memory. Such instructions may be read into system memory from another computer readable/usable medium, such as static storage device or disk drive. In alternative embodiments, hard-wired circuitry may be used in place of or in combination with software instructions to implement the invention. Thus, embodiments of the invention are not limited to any specific combination of hardware circuitry and/or software.

Any use of the word “screen” above should be taken to mean a range of interfaces including but not limited to: a computer screen, a smartphone screen, a tablet screen, or an augmented reality screen or similar interface where a physical screen is lacking. Any references to a screen anywhere above are for the sake of brevity and should not be construed as a limitation on the types of devices or interfaces that can be utilized in various embodiments of this invention.

In an embodiment of the invention, execution of the sequences of instructions to practice the invention is performed by a single computing system. According to other embodiments of the invention, two or more computing systems coupled by a communication link (e.g., LAN, PTSN, or wireless network) may perform the sequence of instructions required to practice the invention in coordination with one another. The system component may transmit and receive messages, data, and instructions, including program, i.e., application code, through communication link(s) and communication interface(s). Received program code may be executed by the processor as it is received, and/or stored in disk drive, or other non-volatile storage for later execution.

Various exemplary embodiments of the invention are described herein. Reference is made to these examples in a non-limiting sense. They are provided to illustrate more broadly applicable aspects of the invention. Various changes may be made to the invention described and equivalents may be substituted without departing from the true spirit and scope of the invention. In addition, many modifications may be made to adapt a particular situation, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the present inventions. All such modifications are intended to be within the scope of claims associated with this disclosure.

Methods recited herein may be carried out in any order of the recited events which is logically possible, as well as in the recited order of events.

In addition, though the invention has been described in reference to several examples optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range, is encompassed within the invention.

Without the use of such exclusive terminology, the term “comprising” in claims associated with this disclosure shall allow for the inclusion of any additional element—irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

Accordingly, it is to be understood that the embodiments of the invention herein described are merely illustrative of the application of the principles of the invention. The breadth of the present invention is not to be limited to the examples provided, illustrated embodiments and/or the subject specification, but rather only by the scope of claim language associated with this disclosure.

### SEQUENCE LISTING

Not Applicable

What is claimed is:

1. An integrated computer-implemented system for providing prescribed homework reminders to patients and monitoring their adherence to the homework so prescribed that is informed by artificial intelligence comprising:
A database configured to store application data (all internal and external programs required to run the system), patient data (demographic, genetic, assessment, diagnosis, treatment, history, outcome, wearable, mobile device, augmented reality device, social network, and totem data), and professional data (assessment, diagnosis, treatment, intervention, prognosis, homework assignment, theoretical orientation, efficacy rating, discipline, and demographic data);
A display configured to receive professional input regarding past, present, and/or future prescribed homework activities and their frequency;
A display configured to display prescribed homework activities to a patient and to prompt the patient to input their current adherence to the homework prescribed;
A display configured to display a patient's current pattern of adherence to prescribed regimen of homework, as reported by patient or patient device input, to a professional;
A computer-implemented processor configured to use artificial intelligence to analyze patterns, to transmit data to and receive data from patients across a range of devices and interfaces (including but not limited to: smart phones, mobile devices, augmented reality displays, wearables, and smart devices), to transmit data to and receive data from a healthcare professional, and to receive and execute commands from one or more healthcare professionals.

2. The system of claim 1, wherein the patient is a person or other entity seeking professional consultation, education, assessment, diagnosis, intervention, or treatment.

3. The system of claim 1, wherein the professional is a person or other entity seeking to offer professional consultation, education, assessment, diagnosis, intervention, or treatment.

4. The system of claim 1, wherein the database has been secured through encryption.

5. The system of claim 1, wherein the computer-implemented processor has been configured to use artificial intelligence (including but not limited to: deep learning, neural network modeling, parallel distributed processing, low-rank matrix factorization, regression analysis, vectorization, and skip thought vectors) to analyze patterns in patient data to initially suggest prognosis as well as advantageous and disadvantageous prescribed homework interventions for an individual patient.

6. The system of claim 1, wherein the computer-implemented processor has been configured to use artificial intelligence (including but not limited to: deep learning, neural network modeling, parallel distributed processing, low-rank matrix factorization, regression analysis, vectorization, and skip thought vectors) to analyze patterns in patient data to suggest possible advantageous changes to currently prescribed patient homework assignments and reminders for an individual patient.

7. The system of claim 1, wherein the computer-implemented processor has been configured to transmit prescribed homework activities to patients across a range of devices and interfaces (including but not limited to: smart phones, mobile devices, augmented reality displays, wearables, and smart devices) and receive feedback about patient adherence to the prescribed homework activities across a range of devices and interfaces.

8. The system of claim 1, wherein the computer-implemented processor has been configured to transmit predictive data and treatment adherence data about a patient to a healthcare professional.

9. A method for using artificial intelligence to assist in the selection of optimal prescribed homework interventions for various states of mental and emotional health and distress.

10. A method for allowing professionals to make informed decisions about patient engagement in prescribed behavioral health homework activities and the fitness of such activities for a patient.
